(19) United States
(12) Patent Application Publication
(10) Pub. No.: US 2016/0344441 A1
(43) Pub. Date: Nov. 24, 2016

(54) MODULAR COMPACT COMMUNICATION AND COMPUTING METHOD AND SYSTEM

(71) Applicant: Umm Al-Qura University, Makkah (SA)

(72) Inventors: Noman Ahmed Shah, Makkah (SA); Imran Ahmed Shah, Lahore (PK); Kamran Ahmed Shah, Leeds (GB)

(21) Appl. No.: 14/718,137

(22) Filed: May 21, 2015

(51) Int. Cl. H04B 1/40; H04L 12/933; H04W 4/00

(52) U.S. Cl. CPC H04B 1/40; H04W 4/008; H04L 49/102

(57) ABSTRACT

A modular compact communication and computer system with wirelessly connected input/output peripherals is disclosed. The system comprises a personal computing system that has a central control unit for operating the system, a data bus for inputting data and commands, an arithmetic unit for calculations, a random access memory, data storage, sensors, a sensor co-processor and security management unit. The computer is also connected to a local input/output, an internal graphic processor, a battery power source and a power management unit with a contact less charger. In addition, the personal computer includes a wireless communication unit that consists of a cellular radio with GMS/GPRS, Sim module, Wi-Fi module, Bluetooth radio, input/output, wireless connectivity radio, software defined radio and wireless serial bus radio.

### FIELD OF THE INVENTION

This invention relates to a modular compact communication and computing method and system and more particularly to a modular compact cellular communication and personal computing method and system with wirelessly connected input/output peripherals.

### BACKGROUND FOR THE INVENTION

In the communication and computer fields size reductions have led to smaller and smaller devices. For example, a U.S. Design Pat. No. D564,366 of Yeh issued Mar. 18, 2008 discloses a Watch With GPS Function while a U.S. Design Pat. No. D594,764 of Ahlstrom issued Jun. 23, 2009 discloses a Combined Case For Wrist Computer Or Wristwatch And Band For Use Therewith.

As the search for smaller and smaller packaging continues a search for more and more complexity with more sophisticated smartphones and computers have grown to the point where I-phones include cameras, Bluetooth connection, Wi-Fi connection, multiple games etc. Multiple applications are also included in computer devices so that many custom devices now carry multiple devices.

Cellular devices such as mobile phones with advanced computing capabilities and connectivity than basic phones already exists. These devices may have added capabilities to perform as a personal digital assistant, media player, photo devices, GPS navigation units with integral features of a touchscreen computer including web browsing, Wi-Fi and operating systems.

Wearable computing devices that are miniature electronic devices worn by a user under, with or on top of clothing are also known.

U.S. Pat. No. 8,684,820 of DeYoung discloses a Virtual Competitive Group Management Systems and Methods that issued on Apr. 1, 2014. As disclosed therein, virtual competitive group management systems and methods may execute methods via one or more processors, which are programmed to compare one or more skill levels of a player to skill levels of a plurality of competitors, wherein a skill level is associated with player competitiveness within the interactive game, determine at least one of the plurality of competitors who have at least one skill level that is greater than the skill level of the player, and place the player and the at least one of the plurality of competitors into a competitive group such that the player is at a competitive disadvantage to at least one of the plurality of competitors.

A second U.S. Pat. No. 8,737,188 of Murgia et al. discloses a Crosstalk Cancellation Systems and Methods. As disclosed therein, systems and methods wherein a far-end acoustic signal may be displayed. Additionally, a crosstalk estimate value for the delayed far-end acoustic signal may be subtracted from an input acoustic signal. The crosstalk estimate value is a sealed version of filter outputs generated by a finite impulse response filter that utilizes predetermined filter coefficients. The filter outputs are scaled using a dynamic gain value.

Finally, a U.S. Pat. No. 8,751,592 of Garcia et al. is directed to Controlling Notification Based On Power Expense And Social Factors. The patent which issued on Jun. 10, 2014, discloses a computer system that determines a wireless transmit cost for each of one or more outgoing messages for a first user, and transmits to the first user's mobile device at least one of the one or more outgoing messages based on the mobile device's power state and respective wireless transmit costs of the one or more outgoing messages.

Notwithstanding the above, it is presently believed that there is a current need and a potential commercial market for an improved modular compact communication and computing system in accordance with the present invention.

### BRIEF SUMMARY OF THE INVENTION

A modular compact communication and computing system with wirelessly connected input/output peripherals comprises or consists of a personal computing unit that includes a central control unit for operating the system. A data bus is included for inputting programs and software as well as data such as programs and information. An arithmetic unit is also included for calculations. The computer also includes random access memory (RAM), data storage, one or more sensors, a sensor co-processor and a security management system. The personal computer is also connected to a local input/output, an internal graphic processor, a battery/power source and a power management unit with a contact less charger. Finally, the personal computer unit includes a wireless communication unit that consists of a cellular radio with GSM/GPRS, Sim module, Wi-Fi module, Bluetooth radio, Input/Output, wireless connectivity radio, software defined radio and wireless serial bus radio.

In essence, the system includes two main units, a first unit including a modular compact communication and computing device and a second unit comprising a number of input/output peripheral devices operatively connected to the first unit with one or more peripheral devices simultaneously running on the same or different applications. The unit has several components namely, a processing unit, battery, sensors, wireless communication components, wired and contact less charging system, memory storage and sensors to serve as a self-contained processing and communications system and an audio/display/keyboard/memory components which may be separately attached. Such peripherals are used for input and output of data.

In addition, each of the two main units has modularity such that any component (e.g. RAM, Processor, Wi-Fi chip, Battery etc.) can be replaced to upgrade the entire system.

In addition, an Input/Output (I/O) unit (in general) includes an I/O processing unit, an I/O radio, a display, a display control unit, a touch sensing monitor or screen, an audio and one or more sensors.

Still further, in the modular communication system and method with wireless Input/Output peripherals the communication medium between devices and core will be 60 Ghz GiG 802. The numeral 11 followed by AD protocol.

The invention will now be described in connection with the accompanying drawings wherein like reference numbers have been used to designate like parts.

### DESCRIPTION OF THE DRAWINGS

FIG. 1 is a schematic illustration of a modular compact cellular communication and personal computing system and method according to the invention; and

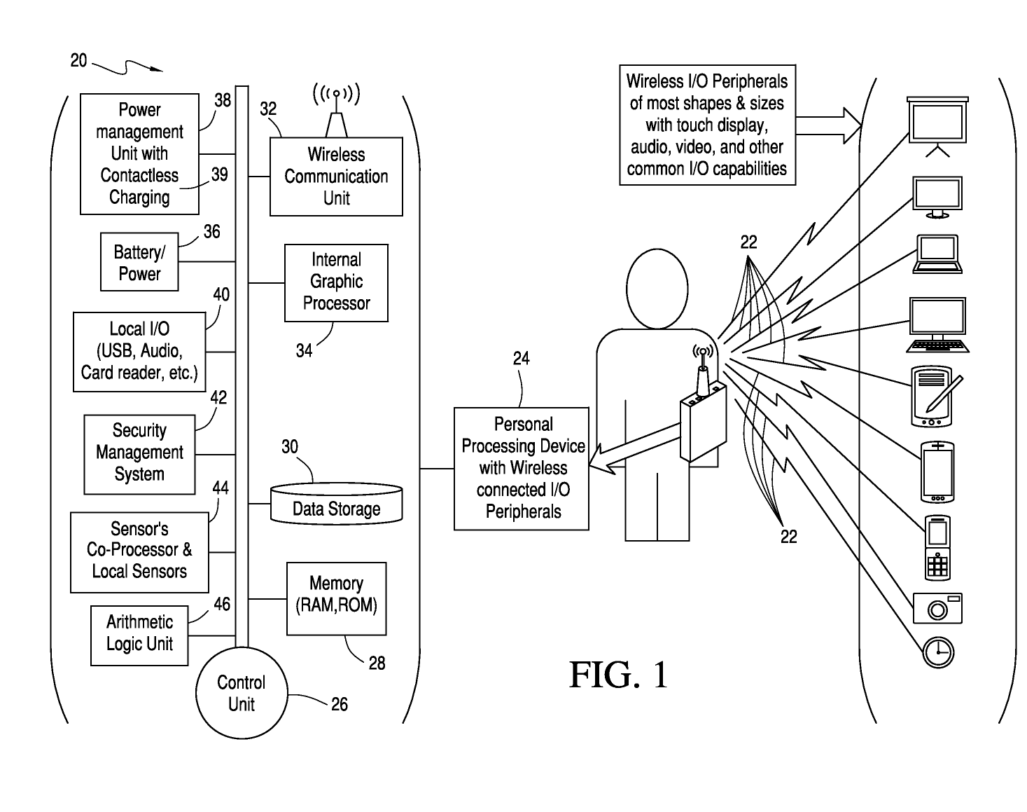

FIG. 2 is a schematic illustration of a method according to a second embodiment of the invention.

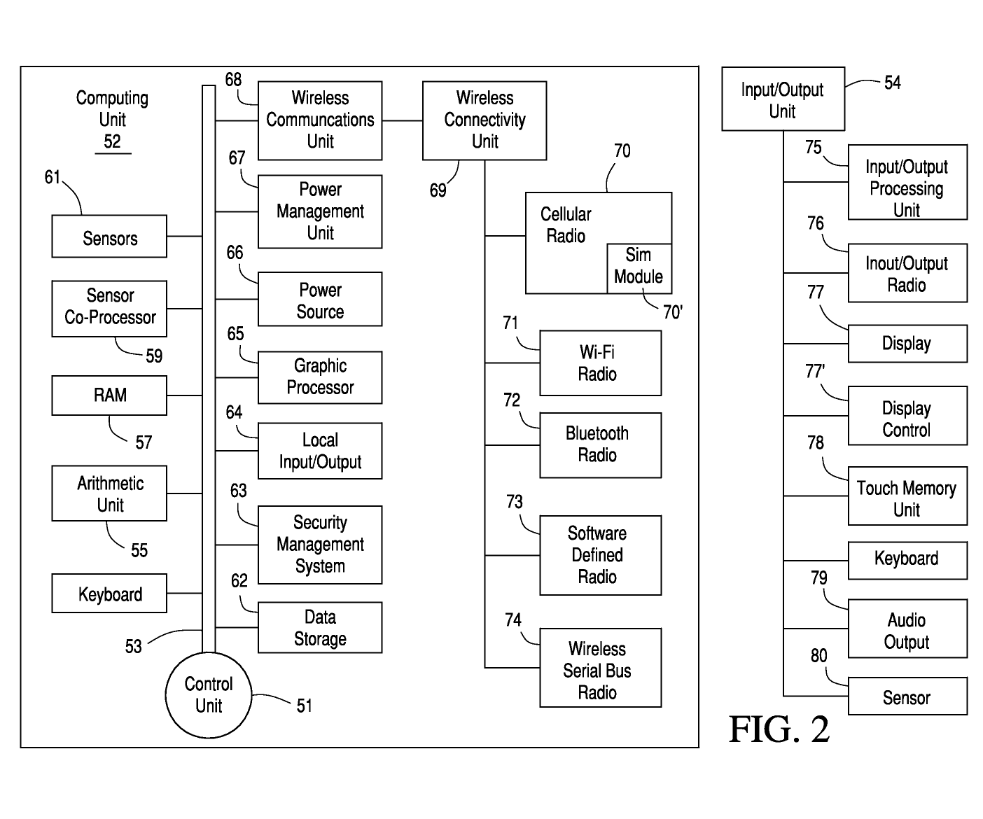

### DETAILED DESCRIPTION OF THE PREFERRED EMBODIMENTS OF THE INVENTION

Personal digital assistant (PDA) mobile devices have been used that function as personal information managers. Personal computers are used in different computing and storage power and different form factor of desktop, laptop, netbook or tablet devices with local area network and/or wireless capabilities.

All of the above-mentioned devices are good for different purposes and one has to keep/carry more than one device for personal computing, entertainment and communication requirements. This involves costs to buy and keep a cellular phone (smartphone) with advanced features, a tablet computer for light travel needs, a laptop for larger screen and better computing power and may be a personal desktop computer for power computing functions.

There is another drawback when the question of upgrading the device comes up. Some individuals replace the entire smartphone, tablet or laptop just for added/new technology features of bigger and sharper screen, better memory, processing power or better camera. This again adds costs.

Energy and space provisions for more than one device in possession may lead to more than one independent device. Next involves costs for operating systems and software and applications which an end user buys separately.

There are other issues involved in keeping more than one device like information security management at many places, data and information sharing among devices locally, over internet or using cloud and again involves concerns of security and integrity of data. There are safety issues, more effort in managing and updating more than one device and transfer and backup of files and data.

The present invention, proposed hereunder is a modular device and method that removes the need to keep various devices for personal computing and communication needs and requirements. The invention also addresses all the above mentioned issues and drawbacks of previous and current devices and technology.

The invention comprises a carryable/wearable/compact personal processing device namely, a Personal Computing Unit (PCU) and wirelessly connected input/output (i/o) peripherals of most shapes and sizes, with touch display, audio, video and other common I/O capabilities, called IO Unit wearable as used herein includes carryable such as disposed in a pocket, small package, brief case or the like.

The PCU will have computing power and capability in terms of multi core processing through control unit, arithmetic logic unit, memory and co-processors for other jobs comparable to a desktop personal computer but of miniature size and weight. It will be able to drive various connected IO Units at same time through parallel computing and multi-cores with no adverse performance effects.

A first embodiment of the invention relates to a carryable/wearable attached or the like modular compact communication and personal computer system 20 with wirelessly connection 22 to Input/Output peripherals of most shapes and sizes with touch display, audio, video and other I/O capabilities. The system 20 includes a personal processing device 24 connected to a control unit 26.

The control unit 26 is connected to a RAM, ROM memory 28, data storage 30, a wireless communication unit 32 as well as an internal graphic processor 34. The control unit 26 is also connected to a power source 36 such as a battery, rechargeable battery, solar cell or the like by means of the control unit 26 to the personal processing device 24.

In one embodiment of the invention, the control unit 26 is connected to a power management unit 38 with a contact less charger 39. The control unit 26 is also connected to a local I/O 40 inclusive of a USB, audio and card reader, a security management system 42. Further, the system 20 includes a sensor processor 43, local sensors 44 as well as an arithmetic logic unit 46.

Sensors connected to the personal processing unit 24 via the control unit 26 may be carried, attached to, worn by an individual. For example, by a wristband, in a pouch or pocket, attached to a belt or the like and may provide environmental conditions such as temperature, pressure, motion, location, etc. Sensors in the peripherals may include ambient light, sound that may adjust the volume of speakers according to surrounding noise, intensity of illumination of a screen as well as other devices.

A second embodiment of the invention relates to a method for communication and computing that includes the step of providing a personal computing unit 52 and an Input/Output unit 54. The personal computing unit 52 includes a control unit 51 for the control and operation of the method and system in accordance with the second embodiment of the invention.

The control unit 51 is linked to a data bus 53 as for example a keypad for inputting data into the system or a step of providing it in the method. As for example, an arithmetic unit 55, random access memory 57, sensor co-processor 59 and sensors 61 may also be provided. Additional links are provided to data storage 62, a security management system 63, a local Input/Output 64 and an internal graphic processor 65. Further, links are provided to a power source 66 such as a rechargeable battery or contact less rechargeable battery, a power management unit 67 with contact less charging and a wireless communication unit 68.

The wireless communication unit 68 is operatively connected to an input wireless connectivity radio 69 that is an essential step and may be operatively connected to a cellular radio 70 with GSM/GPRS and Sim module 70′ and a Wi-Fi radio 71, a Bluetooth radio 72, a software defined radio 73 and a wireless serial bus radio 74.

Software-defined radio (SDR) as used herein is a radio communication system where components that have been typically implemented in hardware (e.g. mixers, filters, amplifiers, modulators/demodulators, detectors, etc.) are instead implemented by means of software on a personal computer or embedded system. While the concept of SDR is not new, the rapidly evolving capabilities of digital electronics render practical many processes which used to be only theoretically possible. Software Defined Radio attempts to place much or most of the complex signal handling involved in communications receivers and transmitters into the digital (DSP) style. In its purest form, and SDR receiver might consist simply of an analog-to-digital convert chip connected to an antenna. All the filtering and signal detection can take place in the digital domain, as for example in an ordinary personal computer.

The Input/Output unit 54 (in general) is operatively connected to an input/output processing unit 75, an input/output radio 76, a display 77 and a display control 77′ each of which are essential. The Input/Output unit 54 may also be operatively connected to a touch memory unit 78, a keyboard, and an audio output 79 such as sensor 80.

In essence a system according to one embodiment of the invention includes two main devices namely, a first modular compact communication and computing device referred to herein as a personal processing device or unit 24 and a second device or unit 50 comprising a plurality of input/output peripherals.

Accordingly, the present invention comprises or consists of a modular compact personal processing device called Personal Computing Unit (PCU) and wirelessly connected input/output (i/o) peripherals of most shapes & sizes, with touch display, audio, video and other common I/O capabilities, called IO Unit.

The PCU will have computing power and capability in terms of multi core processing through a control unit, arithmetic logic unit, memory and co-processors for other jobs comparable to a desktop personal computer but of miniature size and weight. It will be able to drive various connected IO Units at the same time through parallel computing and multi-cores with no adverse performance effect.

The PCU will have user replaceable battery 36, wireless communication unit 32, graphic module 34, local I/O module 40, sensor modules 44, and data storage 30 as well as processor and data bus board.

The graphic module 34 provides all necessary processing, encoding and communication capabilities for IO Unit in collaboration with a control unit and wireless communication unit.

Local I/O units provide ports, audio, card reader, local area network, Bluetooth, infrared and other wired/physically connected connectivity/communication interfaces are included.

There is a power management unit 38 to provide clean and efficient energy to the PCU through battery and/or other energy sources including but not limited to ambient, solar, wind, plugged and kinetic sources.

There will be sensors module that will provide all necessary sensing capabilities as required by device or user in specific model like motion sensors, accelerometer, gyroscope and/or magnetometer, environment sensors, health sensors, 3D & gesture recognition sensors, image sensors etc. These sensing capabilities will be assisted by a sensors co-processor.

User will be able to carry the PCU device in a pocket, on a belt, with a strap, in carry case or any other way of carrying. The IO Units will also have replaceable or rechargeable or disposable batteries. User's will be able to connect various IO Units (in shape and form of cellphone, tablet, laptop, but thinner and lighter than existing smartphones and laptops, using less energy and less cost) and perform necessary computing and/or communication and/or sensing with all data present in one location that is PCU.

While the invention has been described in connection with its preferred embodiments, it should be recognized that changes and modifications may be made therein without departing from the scope of the appended claims.

What is claimed is:

1. A carryable modular compact communication and computing system with wirelessly connected input/output peripherals, said system comprising:
a personal computing unit having a data bus, an arithmetic unit, data storage, security management system, input/output unit, graphic processor, battery/power system, a power management unit with contact less charging and a wireless communication unit including an input/output wireless connectivity radio and wherein the input/output unit includes an input/output processing unit, input/output radio, input/output display and a display control unit.

2. The modular compact communication and computing system with wirelessly connected to input/output peripherals according to claim 1, in which said wireless communication unit includes a cellular radio with GSM/GPRS and Sim module.

3. The modular compact communication and computing system with wirelessly connected input/output peripherals according to claim 2, in which said wireless communication unit includes a Wi-Fi radio.

4. The modular compact communication and computing system with wirelessly connected input/output peripherals according to claim 3, in which said wireless communication unit includes a Bluetooth radio.

5. The modular compact communication and computing system with wirelessly connected input/output peripherals according to claim 4, in which said wireless communication unit includes a software defined radio.

6. The modular compact communication and computing system with wirelessly connected input/output peripherals according to claim 5, which includes a wireless serial bus radio.

7. A modular compact communication and computing system with wirelessly connected input/output peripherals consisting of:
a personal computing unit having a data bus, an arithmetic unit, data storage, security management system, input/output unit, graphic processor, battery/power system, a power management unit with contact less charging and a wireless communication unit including an input/output wireless connectivity radio and wherein the input/output unit includes an input/output processing unit, input/output radio, input/output display and a display control unit.

8. The modular compact communication and computing system with wirelessly connected input/output peripherals according to claim 7, which further consists of a cellular radio with GSM/GPRS, Sim module, a Wi-Fi radio, a Bluetooth radio, a software defined radio and a wireless serial radio.

9. The modular compact communication and computing system with wirelessly connected input/output peripherals according to claim 6, which includes a touch sensing module.

10. The modular compact communication and computing system with wirelessly connected input/output peripherals according to claim 9, in which said input/output unit includes a keyboard.

11. The modular compact communication and computing system with wirelessly connected input/output peripherals according to claim 10, in which said input/output unit includes an audio output.

12. The modular compact communication and computing system with wirelessly connected input/output peripherals according to claim 11, in which said input/output unit includes one or more sensors.

13. A modular compact communication and computing system comprising:
a personal computing unit including a control unit;
a data bus, an arithmetic unit, a random access memory, a sensor co-processor, sensors, data storage and a security management system controllable by said control unit;
a local input/output periphery, an internal graphic processor, a power source including a contact less rechargeable battery, a power management unit with a contact less charger and a wireless communication unit all of which are controlled by said control unit;
wherein said wireless communication unit has access to a wireless connectivity radio; and
an input/output unit has an input/output processing unit, an input/output radio, a display and a display control unit.

14. The modular compact communication and computing system according to claim 13, in which said wireless communication unit is operatively connected to a cellular radio with GSM/GPRS, Sim module, a Wi-Fi radio, a Bluetooth radio, a software defined radio and a wireless serial bus radio.

15. A modular compact communication and computing system consisting of:
a personal computing unit including a control unit;
a data bus, an arithmetic unit, a random access memory, a sensor co-processor, sensors, data storage and a security management system controllable by said control unit;
a local input/output periphery, an internal graphic processor, a power source including a contact less rechargeable battery, a power management unit with a contact less charger and a wireless communication unit all of which are controlled by said control unit;
wherein said wireless communication unit has access to a wireless connectivity radio; and
an input/output unit have an input/output processing unit, an input/output radio, a display and a display control unit and in which said system further consists of;
in which said wireless communication input is operatively connected to a cellular radio with GSM/GPRS, Sim module, a Wi-Fi radio, a Bluetooth radio, a software defined radio and a wireless serial bus radio.

16. A modular compact communication and computing method comprising the steps of:
providing a personal computing unit including a control unit and an input/output unit;
wherein said control unit is operatively connected to a data bus, an arithmetic unit, a random access memory, a sensor co-processor, sensors, data storage and security management system;
a local input/output connection, an internal graphic processor, a power source including a rechargeable battery and a power management unit with a contact less charger and a wireless communication unit;
wherein said wireless communication unit includes a wireless connectivity radio; and
an input/output unit (in general) including an input/output processing unit, an input/output radio, a display and a display control unit.

17. The wearable modular compact communication and computing method according to claim 15, in which said input/output unit includes a touch sensor, a keyboard, an audio subsystem and a plurality of sensors.

18. A modular compact communication and computing system wirelessly connected to a plurality of input/output peripherals comprising:
a main communications and computing unit having a control unit and RAM ROM memory, data storage, internal graphic processor, wireless communications unit, power management unit, battery/power unit, local inputs/outputs, security management system, sensors and arithmetic logic unit operatively connected to said control unit;
a personal processing device operatively connected to said first communication and computing unit; and
a plurality of input/output peripherals operatively connected to said personal processing device and wherein said personal processing device includes audio, video and additional input/output capabilities.

19. A modular compact communication and computing system wirelessly connected to a plurality of input/output peripherals consisting of:
a main communications and computing unit having a control unit and RAM ROM memory, data storage, internal graphic processor, wireless communications unit, power management unit, battery/power unit, local inputs/outputs, security management system, sensors and arithmetic logic unit operatively connected to said control unit;
a personal processing device operatively connected to said first communication and computing unit; and
a plurality of input/output peripherals operatively connected to said personal processing device and wherein said personal processing device includes audio, video and additional input/output capabilities.
